(19) United States
(12) Patent Application Publication
(10) Pub. No.: US 2023/0289744 A1
(43) Pub. Date: Sep. 14, 2023

(54) VEHICLE REPAIR GUIDE SYSTEM

(71) Applicant: Vehicle Service Group, LLC, Madison, IN (US)

(72) Inventor: Brent L. Johnson, Grand Island, NE (US)

(73) Assignee: Vehicle Service Group, LLC, Madison, IN (US)

(21) Appl. No.: 18/118,477

(22) Filed: Mar. 7, 2023

Related U.S. Application Data
(60) Provisional application No. 63/318,121, filed on Mar. 9, 2022.

(51) Int. Cl. G06Q 10/20; G06Q 10/0631; G07C 5/00

(52) U.S. Cl. CPC G06Q 10/20; G06Q 10/06316; G07C 5/006

(57) ABSTRACT

A system and process of repairing a vehicle that has sustained structural or cosmetic damage. The system reviews reported repaired orders and compares those using artificial intelligence to an analysis of the vehicle. Repair procedures for the specific vehicle are then relayed to a user. The user is informed of any specialty equipment needed to perform a portion of that repair. The specialty equipment may then receive a repair program from the system to enable the repair. The user can then place that equipment in queue for appropriate use. Once all structural and cosmetic repairs have been performed, the system reports repair data to a database for later review. The system then determines if any subsequent repairs are need, such as the recalibration of an advanced driver assistance system (ADAS). Should recalibration be required, the system then relays that information to a calibration center and the appropriate calibration is performed and recorded.

### PRIORITY

This application claims priority to U.S. Provisional Application Serial No. 63/318,121, entitled Vehicle Repair Guide System, filed on Mar. 9, 2022, the disclosure of which is incorporated by reference herein.

### BACKGROUND

Once a vehicle becomes damaged, it can take weeks, months, or longer to restore the vehicle to a pre-damaged state. Much of this time is needed because of the many specialized processes, equipment, materials, and personnel necessary to complete a repair. Understanding the extent of the damage is required before a repair facility can provide a customer with an estimated completion date. The repair facility also needs to identify the appropriate repair procedure and ensure that they order the correct materials, have all necessary equipment available, and can schedule personnel with the necessary skills and time to complete the work. Miscalculating even one of these elements may lead to significant delays in repairing the vehicle for the customer and can lead to inefficiencies and further expense due to a potential bottleneck in the repair process, such as, sourcing incorrect or missing parts and equipment, performing the incorrect repair procedure, or repairing components that were not intended to be repaired.

Once a vehicle is ready to be repaired, a facility must then locate and follow the correct procedures to ensure that the repair is comprehensive and safe. Once the repair is complete, the repair facility may record and document the repair to show that the repair was completed in a way that conforms with applicable standards, which can be important for insurance reimbursement and/or subsequent litigation.

Many vehicles also have Advanced Driver-Assistance Systems (ADAS) such as lane-departure warning (LDW) systems, anti-lock braking systems (ABS), adaptive cruise control (ACC), forward collision warning (FCW), and other systems that rely on various sensors, such as one or more of infrared, ultraviolet, and visible-light cameras, LIDAR, RADAR, GPS, and ultrasonic sensors, and others. Once a vehicle has been cosmetically repaired, calibration of an ADAS may be required to make the vehicle roadworthy.

While various kinds of vehicle repair guide systems, methods, and associated components have been made and used, it is believed that no one prior to the inventor(s) has made or used the invention described in the appended claims.

### BRIEF DESCRIPTION OF THE DRAWINGS

While the specification may conclude with claims that particularly point out and distinctly claim the invention, it is believed the present invention will be better understood from the following description of certain examples taken in conjunction with the accompanying drawings, in which like reference numerals identify the same elements, and in which:

FIG. 1 depicts a flowchart for assessment of a damaged vehicle prior to repairing the vehicle.

FIG. 2 depicts a flowchart for repairing a damaged vehicle.

FIG. 3 depicts a flowchart for calibrating an ADAS system of a damaged vehicle.

FIG. 4 is a schematic diagram of a processing device for use in the described system.

FIG. 5 depicts a Vehicle Damage Assessment Apparatus for assessing structural or cosmetic damage on a vehicle.

FIG. 6 depicts a Vehicle Damage Repair Apparatus for repairing vehicle damage.

FIG. 7 depicts a Vehicle ADAS Calibration Apparatus for calibrating one or more vehicle ADAS systems after damage repair.

### DETAILED DESCRIPTION

The following description of certain examples of the invention should not be used to limit the scope of the present invention. Other examples, features, aspects, embodiments, and advantages of the invention will become apparent to those skilled in the art from the following description, which is, by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

### I. Vehicle Damage Assessment

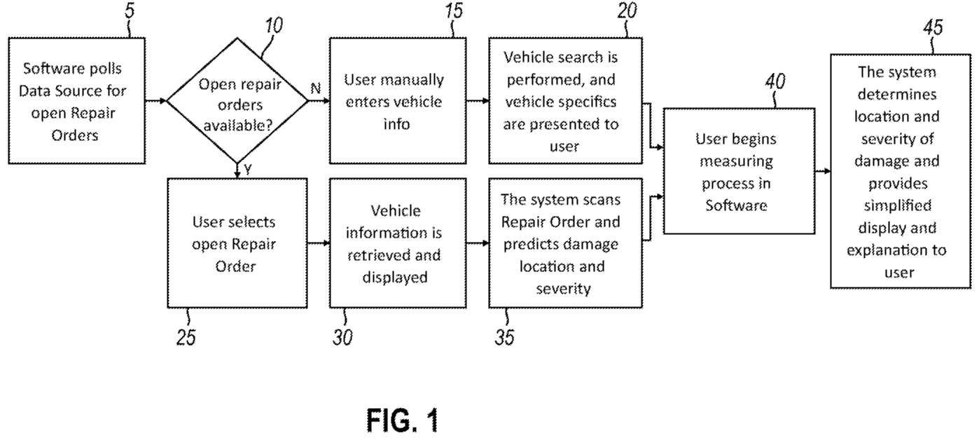

FIG. 1 depicts an illustrative vehicle assessment flowchart, showing a process that an embodiment may use for assessing vehicle damage (e.g., the severity and location of any mechanical, interior, or exterior damage) and for generating and/or verifying damage data that may be used to determine a proper repair procedure for the vehicle. In one embodiment, a damaged vehicle may present itself at a facility and require repairing. A vehicle may present itself to the facility under its own power or may requiring towing due to the extent of the damage. The facility may have prior knowledge of the vehicle and the damage through a prior inspection, an insurance assessment, a competitor’s estimate, or by any other means capable of relaying damage and vehicle information to the facility.

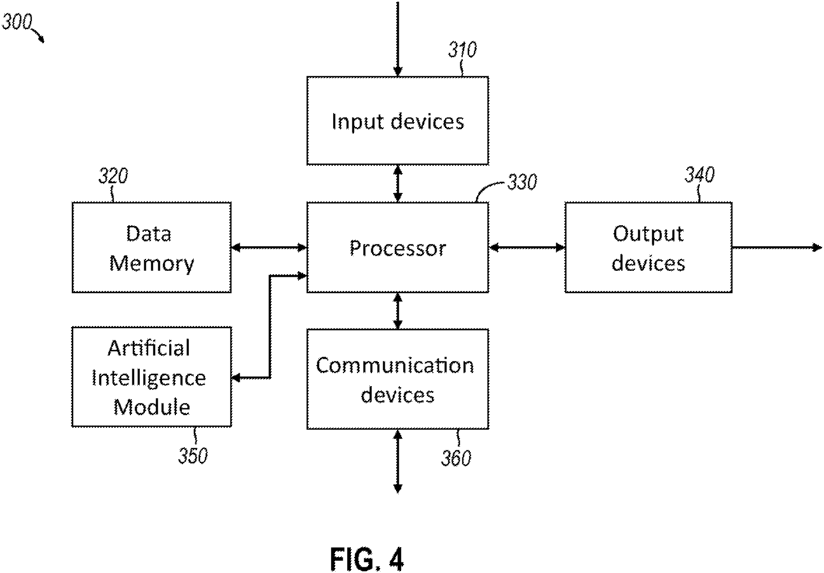

In some implementations, a user (e.g., a repair technician) may perform a poll for any open repair orders (ROs) on that vehicle (5) using the processing subsystem shown in FIG. 4 (described below) and loaded with a software package capable of retrieving ROs. The poll may use various information, e.g., vehicle-specific information, such as a vehicle identification number, the year/make/model of the vehicle, or vehicle trim/options/accessories, owner information, the vehicle’s license plate number or registration number, or any other information capable of retrieving a repair order on that vehicle. In some implementations, the system may be capable of retrieving RO information from local and/or remote data sources and may even retrieve and report prior ROs to the user. In an alternative implementation, the system may automatically perform a poll for any open ROs on the vehicle (5). Such automatic polling may be triggered by various events, such as, for example, receiving intake data collected when the vehicle arrived at the repair shop or receiving an electronic notification of a pending RO from a third party (e.g., an insurance company, vehicle title owner, vehicle user, etc.).

Based on the RO poll, the system can determine whether an RO is available (10). If an existing RO is available, that RO may be selected (25) for analysis and can be compared to prior ROs of the same or similar vehicles for comparison by the technician. In some embodiments, the RO selection (25) may be performed based on input from a user/technician. Additionally, or alternatively, in some implementations, the system may automatically select and/or display a specific RO when a user requests information on an associated vehicle or based on a schedule or algorithm. The system may display the RO in various ways, such as, for example, one or more of text, images, pictures, renderings, 3D models, scans, auditory communications, tactile communications, recordings, and other means reasonably adapted to relay RO information to a user.

In some implementations, the system prompts the user to review or work on a specific RO based on a queue or calendar system that schedules the user/technician’s next task. In some implementations, the system may automatically select an RO based on the type of repairs currently being performed in the facility or for which an available technician is trained, certified, or otherwise capable. By way of non-limiting example, if a first vehicle is being repainted using paint code 10U and a second car is later scheduled to be painted with paint code 10U, the system may identify this and notify the user to paint the vehicles together, thus improving efficiency. For example, performing a group painting process may only require mixing one batch of paint and only cleaning tools (e.g., a spray gun) once. Group panting will likely also decrease the cost of supplies due to the reduction in waste.

Once the proper RO is selected (25), the system may then retrieve and/or display all or a portion of the vehicle damage data (30). In some embodiments, the system may retrieve or detect, or the user may enter, the vehicle identification number (VIN) to determine any additional pertinent aspects of the vehicle that may be known, such as, for example, the make, model, year, aftermarket modifications, build sheets, etc. As shown, once all the relevant vehicle information has been imported or captured by the system it may display the relevant information (e.g., with an annotated rendering of the vehicle) to the user (30).

The system then uses the RO and vehicle damage estimate data to predict vehicle damage location and severity (35) before the vehicle is analyzed and/or the predicted damage is verified. Prediction of the damage location may come from sources such as technician inputs, estimate inputs, statistics regarding damage to a particular type of vehicle, past owner damage, or vehicle modification information. As an example of damage statistics, the HUMMER H1, produced by AM General, is 86.5″ in width and is one of the widest passenger vehicles ever produced. Drivers of this vehicle commonly underestimate its width and frequently impact the front passenger side with adjacent objects. If a frontal crash were reported involving a HUMMER H1, the system would be able to determine the increased statistical likelihood that the passenger-side front fender will require replacement rather than the driver front fender.

In a further embodiment, the prediction of the severity may include a repair cost component. Following the prior example, because HUMMER H1 passenger-side fenders are no longer produced, and because passenger-side fenders are increasingly difficult to source due to increased consumption, the system would be able to include the increased cost of a passenger-side fender into the prediction. As an example of the prediction of the severity of the damage, this may include an estimate of the value of the vehicle immediately before the damage occurred and an estimate of the value of the vehicle after the repair is performed, which may further include a depreciated value due to the car no longer having a clean damage history. If an estimated cost of repair exceeds or is a particular fraction of the vehicle’s value after repair, the system may warn the user that the damage analysis and repair should be reconsidered.

In some embodiments, an RO may not exist or be available for the vehicle. Thus, a user/technician may be required to manually enter some or all of the information into the system (15). Accordingly, the user may collect and enter relevant information about the vehicle, such as the VIN, make, model, year, mileage, build sheet, build sticker, window sticker, aftermarket parts, etc. (15). The system may also report customer, insurance, and regulatory preferences and additional repairs requested by those parties and include those in the new or existing RO. As an example, if the customer prefers to keep costs low and only source used parts rather than new parts, the system can report this to the user/technician. As another example, if the customer prefers to perform the repair in a certain manner, such as to use a base/clear coat paint rather than a single-stage paint, the system can report this to the user/technician. As another example, if the payor has a reduced contract parts rate (e.g., where they get a discount on parts if sourced from a particular supplier), the system can report this to the user/technician. The system can also include additional information related to repairs or modifications which are beyond the extent of the immediate damage, such as repainting the entire car rather than simply painting the repaired portions. The system may then analyze the vehicle information (e.g., identify and obtain relevant manufacturer information) and present it to the user for review (20).

Accordingly, as described above, regardless of whether a vehicle repair corresponds to a new or existing RO, the system can provide the proper tools and technology to collect, analyze, and verify any relevant vehicle information. Once the system has collected/aggregated all the necessary data, a user may then begin the measuring process to determine and/or verify the damage (e.g., the actual severity and location of any interior or exterior damage) (40). It should be understood that the measuring process (40) may comprise electronic equipment (e.g., smart tools) as well as typical physical tools. Thus, in some embodiments, the system may automatically collect measurement data (e.g., via a wired or wireless connection to the electronic equipment), while in other embodiments, the user may be required to manually input the measured characteristics of the vehicle and/or vehicle damage.

In some embodiments, the vehicle may be capable of self-reporting damage that it has sustained. The vehicle may be able to report damage to the system either locally (e.g., when the vehicle is at the facility) or remotely, including by using a remote data source. Common examples of self-reporting damage are burned-out headlight warnings, air bag malfunction warnings, tire malfunction warnings, low engine coolant warnings, and EV battery malfunction warnings.

Once the vehicle information has been obtained by the system and the vehicle has been assessed/verified, the system may determine the severity and location of the damage and provide a simplified display and explanation to of the damage (45). Display of the damage may appear, similar to the RO, as any combination of text, images, pictures, renderings, 3D models, scans, auditory communications, tactile communications, recordings, or through any means reasonable to communicate damage information to a user. The RO and vehicle damage data then can be recorded into a data source, and repair of the vehicle may begin.

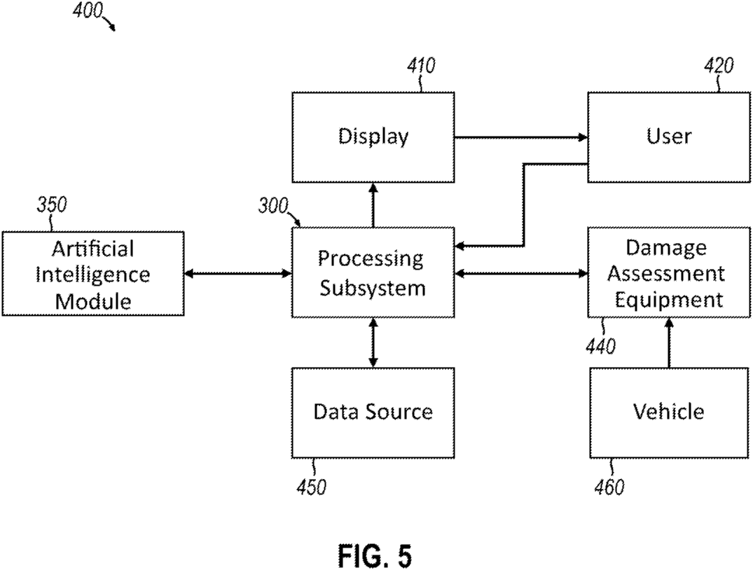

FIG. 5 shows an exemplary vehicle damage assessment apparatus (400) used to aid in performing the steps for assessment of a damaged vehicle. Assessment apparatus (400) includes a processing subsystem (300), later described in detail, at least one data source (450) in communication with the processing subsystem (300), a display (410) in communication with the processing subsystem (300) and used to relay information to a user (420), damage assessment equipment (440) in communication with the processing subsystem (300) used to assess a damaged vehicle (460), and an artificial intelligence (AI) module (350), described herein. The vehicle damage assessment apparatus (400) may comprise the same or different components of the vehicle damage repair apparatus (401) and the vehicle ADAS calibration apparatus (402), which is discussed below.

The damage assessment equipment (400) is used to generate a set of vehicle damage data and to report that data to the processing subsystem (300) for subsequent analysis. The damage assessment equipment (440) can include multiple pieces of equipment, where each piece can assess a different portion of damage and can generate a different set of vehicle damage data. Each piece of equipment can be used independently or in combination with any other piece of equipment. Examples of the damage assessment equipment include 3-dimensional scanners (such as the Constellation Hail Scanner by Chief Collision Technology), micrometers, bore scopes, electrical multimeters, on-board diagnostic scanners, and pressure gauges.

Multiple data sources (450) can be included in the system and can be stored locally and/or remotely. Data sources (450) can provide data to the processing subsystem (300) which provides information to a user (420), including for example information about the damaged vehicle (460), similar vehicles, available and/or selected repair procedures, consumables for the selected repair(s), damage assessment equipment (440), and facility data.

### II. Vehicle Damage Repair

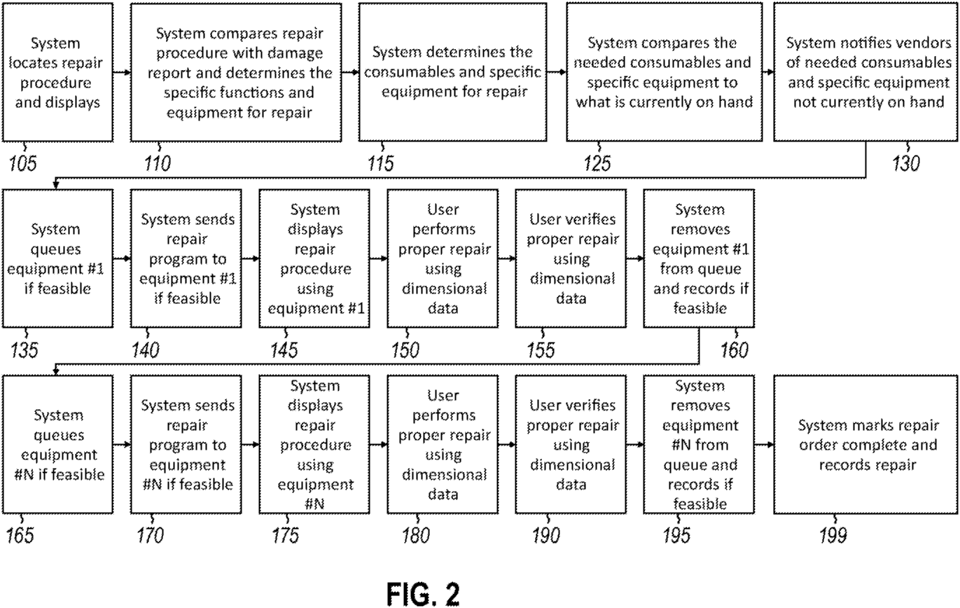

Referring now to FIG. 2, an illustrative vehicle repair flowchart is shown. In an embodiment, the system may, based on the above-obtained vehicle information, locate a repair procedure specifically associated with the vehicle and the damage it received (105). For example, the system may communicate with, or search, various sources of vehicle information to identify one or more relevant repair procedures. Although the primary source for repair procedures may be manufacturer databases, it should be understood that the system may utilize a plurality of sources, such as, for example, procedures created by the repair facility itself, procedures created by an aftermarket manufacturer, procedures from the vehicle manufacturer, procedures from a component manufacturer, procedures from a repair publication vendor, or any other suitable source.

In some embodiments, numerous different repair procedures may be presented to the user based on different factors and coming from different sources. As discussed herein, the system may retrieve repair procedures from various sources. The AI module may then evaluate each potential repair procedure using a repair algorithm. As will be discussed in greater detail below, the AI module, which may be incorporated into the system at large, may review and evaluate repair procedures and repair procedures steps to learn and adapt (e.g., create a customized algorithm) to help improve the repair process. Although the current disclosure references the AI module generally, it should be understood that various types and techniques of AI and machine learning (ML) may be utilized. By way of non-limiting example, the AI module may include a recursive neural network such as feed-forward neural networks, multilayer perceptrons, convolutional neural networks, radial basis function neural networks, recurrent neural networks, sequence-to-sequence models, modular neural networks, and the like. Some AI modules may apply other AI/MI, techniques as will occur to those skilled in the art.

By way of non-limiting example, to replace a damaged door, a first procedure may be presented from the vehicle manufacturer, while a second procedure may be presented from an aftermarket manufacturer. As another example, a manufacturer’s procedure to replace a fender bonded to a vehicle may include a specific number of rivets, while an alternative procedure (e.g., sourced from a repair blog) may include additional rivets to account for a known weak point in the bond. Thus, as discussed herein, it should be understood that the repair procedures may be stored locally or remotely and may be obtained from multiple data sources.

The system may also combine different repair procedures from different procedure sources and for repairs that are different than the ones identified in the RO. Thus, in some embodiments, the system may combine common steps from multiple procedures into one common procedure that only presents a single step. This may allow for more accurate time and cost estimates for a combined repair. As an example, if a vehicle is involved in a front side impact where the front fender and radiator support are damaged, a front fender repair procedure may include repair time for removing the front bumper but not the radiator support. Meanwhile, a repair procedure for the radiator support may also include repair time for removing the front bumper but not the front fender. Traditionally, in an example like this, a customer may have been charged twice for the removal of the front bumper because the facility would have simply combined the estimated time and cost from both procedures, or the facility would have to guess the duplicated bumper removal time and manually remove that time and cost from the estimate.

A user can select the appropriate repair procedure from the offered procedures, or the AI module may recommend or select the most appropriate repair procedure based on the availability of tools at the facility and/or repair history variables (110). As mentioned previously with respect to modifying repair procedures, the AI module may also modify any existing repair procedure to better accommodate a facility in the repair of the vehicle. The AI module can have access to facility-specific data such as vendor, consumable inventory, employee, equipment, and work history data when modifying the appropriate repair procedure.

Using the available information, the system may present and select the most efficient and least costly procedure to follow. Alternatively, the system can present the fastest repair method, even though it may not be the most cost-conscious. If the procedure that is selected deviates from the requests of the customer, payor, or laws of the area, the system can present the user a warning regarding this deviation and offer conforming alternatives for the user to follow. The user then has the option to override the warning or to follow an alternative.

Once the appropriate repair procedure is selected, repair of the vehicle may begin. With access to facility data, the system can determine what parts, consumables, and specific repair equipment may be needed to perform the repair (115). The system can then query the existing inventory of consumables and compare that to a list of consumables needed to complete the selected repair procedure (125). The queried list of consumables may include consumables that are preferred by any party, such as the facility, customer, or payor, and other consumables that may be more readily available. In some embodiments, if any needed consumables are not currently on hand, the system may place the order directly with a vendor and/or alert a user that they will need to order the materials to complete the repair (130). If the user is required to manually order the parts, the system may, in some embodiments, automatically populate an order form with the correct items (e.g., name, part number, quantity, etc.). The system may also display a list of potential vendors for the user to contact to obtain the required consumables. In other embodiments, the system may reserve the needed consumables and directly or indirectly initiate the order if the remaining level of inventory is below a particular threshold.

The system can also present a list of vehicle parts that are needed to perform the repair, such as doors, fenders, hoods, taillights, etc. The system can query local and remote data sources for price, condition, and availability and other metrics needed to determine which parts should be sourced. A user can then be presented with a list of parts, then select the parts that they would like to use for the repair. Once the parts have been selected, the system can either place an order with the vendor or mark the inventory as reserved from the facility’s own inventory. Once the parts have been selected, the system can then cost the parts plus any mark-up to an account of the vehicle repair for financial accounting and billing purposes. If advance payment is required from the payor, the system can alert the user if the cost of the goods exceeds the reserve placed by the payor.

In certain geographic and legislative areas, vehicle repairs are required to record the vehicle identification number of major components to ensure that the components are not stolen. The system may ensure that a component vehicle identification number is available and that it has not been reported as stolen prior to allowing a user to order and use the component. The system can present past supplier purchases, supplier volume, supplier reputation, return policies, and the likelihood that the component is the component that is needed for the repair to the user. Once an order is placed, the system can then record component vehicle identification numbers and any other identifying information in either a remote or local data source for later reference.

The system may also query a list of equipment needed to perform each step of the repair procedure. If any damage repair equipment needed for the repair is not currently on hand, the system may issue an alert to the user that the equipment will be needed to complete the repair (130). If a necessary item of damage repair equipment is available at the facility, the system may place the requirement for use of that equipment in a queue or otherwise reserve the equipment so that the equipment is not otherwise in use when the vehicle is ready to have that particular step performed (135).

The system can consider the requests of the customer or third party when reserving the vehicle repair equipment, then reserve or prompt a user to use different vehicle repair equipment. As an example, if the system were to default to the use of a stick welder to perform a repair due to the low cost, the user could override this if the customer had requested the use of a MIG welder because it generates less weld spatter in the surrounding area.

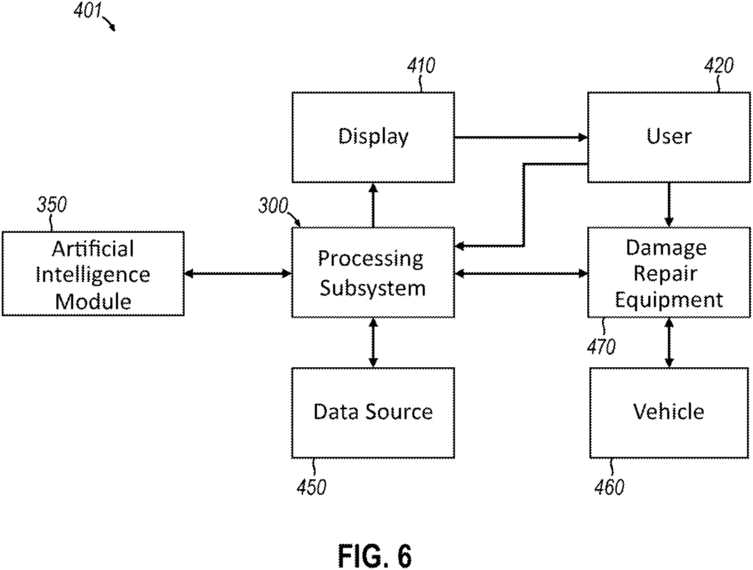

Turning to the vehicle damage repair apparatus, FIG. 6 depicts a vehicle damage repair apparatus (401) for repairing a damaged vehicle (460). Vehicle damage repair apparatus (401) includes a processing subsystem (300) in communication with a user (420), a display (410), at least one piece of damage repair equipment (470), at least one data source (450), and an AI module (350). The vehicle damage repair apparatus (401) may comprise the same or different components of the vehicle damage assessment apparatus (400) and the vehicle ADAS calibration apparatus (402), which is discussed below.

The vehicle damage repair apparatus (401) can be in communication with the damaged vehicle (460), the user (420), and the processing subsystem (300). This equipment may include anything necessary to repair a damaged vehicle (460), including equipment to repair the body, the structural elements, the interior, safety components, glass, or drivetrain. Examples of damage repair equipment (470) may include a rivet gun, welder, frame puller, paint equipment, various hand tools, and other equipment as will occur to those skilled in the art. The damage repair equipment (470) may be made operable through instructions and control provided by either the user (420) or the processing subsystem (300), or it may be self-operable so that no input is required in order to perform the repair. The processing subsystem (300) may receive continuous feedback and provide continuous instruction to the damage repair equipment (470) based on revised data regarding the repair.

The vehicle damage repair apparatus (401) may also be used in conjunction with the vehicle damage assessment apparatus (400) so that as a vehicle is being repaired, it is also being assessed to understand the extent of the repair. As an example, a vehicle may require damage repair equipment (470) in the form of a frame puller to repair a damaged frame. As the frame puller is straightening a damaged frame, the vehicle damage assessment apparatus (400) may continuously monitor the condition of the frame to inform the user (420) and/or the vehicle frame puller once the frame has been adequately repaired.

Turning back to the vehicle repair flowchart of FIG. 2, many vehicle repairs that require specific equipment may also require that the specific equipment be programed to make that equipment operable to perform the repair. The processing subsystem, in communication with the AI module, can assess whether the equipment requires specific programming and can access the various data sources to retrieve the programs. The system can then relay those programs and RO information to the equipment to make the equipment operable for the repair (140). The system can then send program information such as version and release data to a separate data source to record the specific program used to repair the vehicle. The system will then present the repair procedure to the user on a display (145) so that the user can use that repair equipment to perform the repair step (150).

Once the parts and consumables are ready to be used for the repair (150), the system may prompt the user to confirm that the identified parts and consumables are being used. Considerable time may have passed between ordering the parts and consumables and using them. The system may confirm that the part order is still appropriate, and that the user has not retrieved the wrong part from inventory. The system may also be able to notify the user if a consumable has surpassed its recommended shelf life and should not be used for the repair. This can occur in consumables such as adhesives and coatings that have low inventory turnover. If a consumable is needed for this reason, the system may prompt the user to reorder the consumable.

Once the parts, equipment, and consumables have been used to complete a particular step of the repair procedure, a user can then verify that the step was performed correctly by analyzing the repair using vehicle damage assessment equipment (155) to generate repair data and comparing the repair data to expected dimensional data supplied by the processing subsystem. If the repair data deviates from the expected dimensional data beyond a specified tolerance, the user may be prompted to continue the repair until no deviation exists. Once the repair step has been performed and verified by the system, the system may then remove the reservation on the equipment just used (160). The system may also record information about the completed step into either a local or remote data source (160). Recording repair steps during the repair is useful in situations where the repair cannot be easily observed later, such as when the repaired portion is inaccessible. The user can repeat the repair process any number of times while using the same or different equipment to complete different steps of the repair procedure (165, 170, 175, 180, 190, 195). Once all the steps of the repair procedure have been performed and verified, the RO can be labeled as complete in the system (199). Repair data can then be sent to a data source as part of a vehicle history file and to confirm to the customer and the payor that the repair was properly completed (199).

### III. Vehicle ADAS Calibration

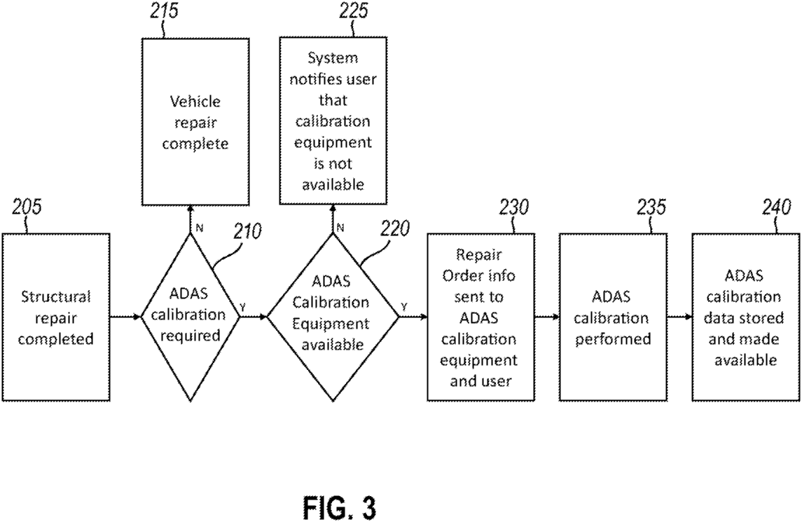

FIG. 3 depicts a vehicle ADAS calibration procedure flowchart for calibrating an ADAS of a repaired vehicle. Once a damaged vehicle has been repaired, an ADAS system may need to be calibrated to function properly. This may be because either a component of the ADAS system was repaired or replaced, ADAS equipment was realigned or otherwise positionally affected by the repair, or because the ADAS system was reset because of the repair. As an example, if a lane-departure ADAS component is replaced, the ADAS may require that it be calibrated before it will function properly.

After a vehicle has been repaired (205), the processing subsystem (300), using the AI module, reviews the appropriate repair procedure to determine if ADAS calibration is required (210). If required, the processing subsystem determines whether the appropriate calibration equipment is available for calibration (220).

If the appropriate calibration equipment is not available, then the processing subsystem alerts the user on the display that calibration of an ADAS is required (225). In this situation, the system may also warn or prohibit the user from releasing the vehicle from the facility. The system might either hold the vehicle until it has been calibrated or prompt a user to override the prompt for release of the vehicle in an uncalibrated condition. The system can then record to either a local or remote data source that the warning had been overridden and/or that the vehicle was released in an uncalibrated condition.

If the appropriate calibration equipment is available for calibration, processing subsystem communicates to the equipment and to a user using the equipment the specifics of the calibration (230). The specifics of the calibration may include information such as the RO, VIN, the repair procedure performed, the ADAS components needing calibration, and any specific program or software required to perform the calibration. The ADAS calibration is then performed (235), and the processing subsystem marks the RO complete in the software package and uploads calibration data from the performed ADAS calibration to a data source (240).

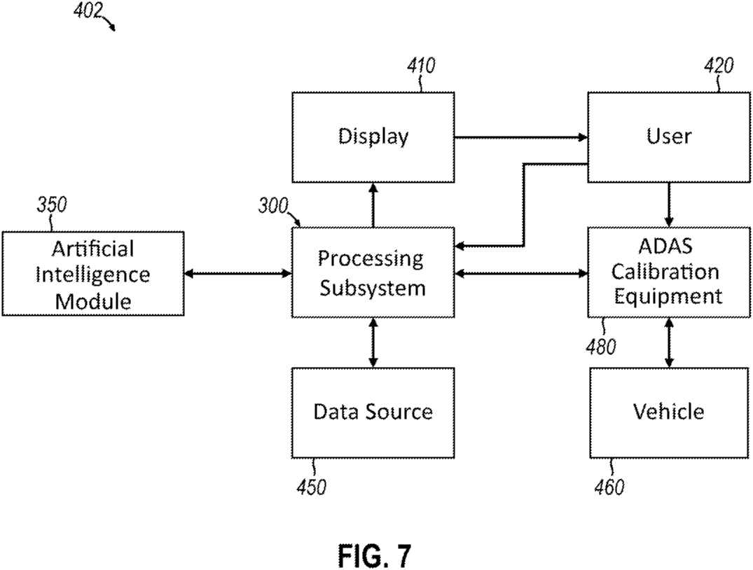

FIG. 7 depicts a vehicle ADAS calibration apparatus (402) for calibration of a vehicle ADAS after a damaged vehicle (460) has been repaired. The vehicle ADAS calibration apparatus (402) may comprise any of the components of the prior vehicle damage assessment apparatus (400) and vehicle damage repair apparatus (401), but vehicle ADAS calibration apparatus (402) may also include at least one type of vehicle ADAS calibration equipment (480), which may be in communication with the repaired vehicle (460), a user (420), a processing subsystem (300), and other components as will occur to those skilled in the art. The vehicle ADAS calibration apparatus (402) may comprise the same or different components from the vehicle damage assessment apparatus (400) and the vehicle damage repair apparatus (401).

### IV. Overview of Exemplary Vehicle Repair Guide Systems

Each of the various items described herein as control systems, computers, calibration systems, controllers, processors, and the like may be implemented together or separately as one or more computers, proprietary computing devices, or virtual computing environments. Each of these, exemplified in FIG. 4 as processing subsystem (300), may include a processor (330) and a memory (320) that are each located locally and/or remotely to each other. Processor (330) in some embodiments is a microcontroller or general-purpose microprocessor that reads its program from memory. Processor (330) may comprise one or more components configured as a single unit. Alternatively, when of a multi-component form, processor (330) may have one or more components located remotely relative to the others.

One or more components of the processor may be of the electronic variety including digital circuitry, analog circuitry, or both. In some embodiments, the processor is of a conventional, integrated circuit microprocessor arrangement, such as one or more CORE i5, i7, or i9 processors from INTEL Corporation of 2200 Mission College Boulevard, Santa Clara, California 95052, USA, or BEEMA, EPYC, or RYZEN processors from Advanced Micro Devices, 2485 Augustine Drive, Santa Clara, California 95054, USA. In alternative embodiments, one or more reduced instruction set computer (RISC) processors, application-specific integrated circuits (ASICs), general-purpose microprocessors, programmable logic arrays, or other devices may be used alone or in combinations as will occur to those skilled in the art.

Likewise, memory (320) in various embodiments includes one or more types such as solid-state electronic memory, magnetic memory, or optical memory, just to name a few. By way of non-limiting examples, memory can include solid-state electronic random access memory (RAM), sequentially accessible memory (SAM) (such as the first-in, first-out (FIFO) variety or the last-in first-out (LIFO) variety), programmable read-only memory (PROM), electrically programmable read-only memory (EPROM), or electrically erasable programmable read-only memory (EEPROM); an optical disc memory (such as a recordable, rewritable, or read-only DVD or CD-ROM); a magnetically encoded hard drive, floppy disk, tape, or cartridge medium; a solid-state or hybrid drive; or a plurality and/or combination of these memory types. Also, the memory in various embodiments is volatile, nonvolatile, or a combination of volatile and nonvolatile varieties.

Computer programs implementing the functions, actions, and methods described herein will commonly be stored, distributed, and/or updated either on a physical distribution medium, such as DVD-ROM, or via a network distribution medium such as an internet protocol or other communication network, using other media, or through some combination of such distribution media. From there, they will often be copied to a memory. When the programs are to be run, they are loaded either from their distribution medium or their intermediate storage medium into the execution memory of the computer, configuring the computer to act in accordance with the method described herein.

Processing subsystem (300) may also include one or more input devices (310) that receive information from other devices as will occur to those skilled in the art. Various embodiments will include input devices (310) such as one or more pointing devices, touch screens, microphones, photographic and/or video capture devices, fingerprint readers, other input devices (310), and combinations thereof as will occur to those skilled in the art. Likewise, processing subsystem (300) may also include one or more output devices (340) that send information to other devices as will occur to those skilled in the art. Various embodiments will include output devices (340) such as monitors, headphones, speakers, touchscreens, tactile output devices, lights, alarms, klaxons, other output devices, and combinations thereof as will occur to those skilled in the art. Still further, processing subsystem (300) may include one or more communication devices (360), such as network adapters, WI-FI transceivers, BLUETOOTH transceivers, ethernet adapters, USB adapters, other wireless and wired connection devices capable of transmitting and/or receiving data and/or power, and combinations thereof as will occur to those skilled in the art. The communication device (360) may put the processor in communication with additional devices and data sources (450), which may include network communication devices (such as routers and switches), the Internet, sensors, output devices, lifts, scanners, databases, archives, and other devices as will occur to those skilled in the art.

A local display (410) may be proximate to the processing subsystem (300) and operable by the processor (330) to display interfaces and information to users (420) of the assessment, repair, or advanced driver-assistance systems (ADAS) calibration system and accept user confirmations and process control input. In some embodiments, such input and output are achievable and/or may be monitored through remote devices through a local- or wide-area network as will occur to those skilled in the art.

The processing subsystem (300) is in communication with an artificial intelligence (AI) module (350) that includes self-learning AI programming. The AI module (350) may be locally or remotely located relative to other components in processing subsystem (300). Generally, AI module (350) can take various inputs and modify various outputs, based on those inputs, to the benefit of the user. This can improve the efficiency of performing a task related to vehicle assessment, repair, and calibration. As an example, AI module (350) can evaluate a geometric scan of a vehicle (460), photographs of the vehicle (460), and the like, collectively presented as damage data, and compare the information to items and data in a corresponding damage estimate to predict the severity and location of the damage and the length of time it will take a particular shop to perform the repair. AI module (350) can also evaluate damage data of vehicle (460) and compare that to a set of repair procedures stored in a data memory (320) or data source (450), as well as how the same and/or other repair facilities have conducted similar repairs in the past. The AI module (350) can then recommend deviations or alternative steps to improve the repair procedure.

When an act or function is described herein as occurring “based on” or “as a function of” a particular thing, the system is configured so that the act or function is performed in different ways depending on one or more characteristics of the thing. When an act or function is described herein as being performed “based exclusively on” or “solely as a function of” a particular thing, the act or function is performed in different ways depending on one or more characteristics of the thing, but the way is completely determined by the one or more characteristics of the thing.

For simplicity, various power, ground, timing, communication, heartbeat, and other connections, facilities, and resources have not been illustrated or mentioned, though they are present and generally available to all applicable items mentioned herein as will occur to those skilled in the art.

It should be appreciated that any patent, publication, or other disclosure material, in whole or in part, that is said to be incorporated by reference herein is incorporated herein only to the extent that the incorporated material does not conflict with definitions, statements, or other disclosure material set forth in this disclosure. As such, and to the extent necessary, the disclosure as explicitly set forth herein supersedes any conflicting material incorporated herein by reference. More specifically, any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A system, comprising:
a display,
a processor, and
a memory storing instructions that comprise an artificial intelligence module and cause the processor to:
receive damage assessment data associated with a vehicle;
obtain, based on the damage assessment data, a repair process from a third party;
determine, using the artificial intelligence module, at least one repair step for the vehicle based on the repair process and a customized repair algorithm;
present, using the display, the at least one repair step to a user;
determine, using the processor, at least one repair success metric associated with the at least one step; and
modify, based on a repair success metric, the customized repair algorithm.

2. The system of claim 1, wherein identifying the at least one repair step for the vehicle comprising identifying a plurality of steps for repairing the vehicle.

3. The system of claim 2, wherein a first one of the plurality of steps is an alternative to a second one of the plurality of steps for repairing the vehicle.

4. The system of claim 1, wherein the receiving of the damage assessment data comprises receiving a repair order, and wherein the damage assessment data is included in the repair order.

5. The system of claim 1, wherein the at least one repair success metric comprises user input associated with at least one of: the damage assessment data, the vehicle, the at least one repair step, and the customized repair algorithm.

6. The system of claim 1, wherein the receiving of the damage assessment data further comprises obtaining, from a laser scanner, a geometry of the vehicle.

7. The system of claim 1, wherein the third party comprises a vehicle manufacturer.

8. The system of claim 1, wherein the damage assessment data comprises a vehicle identification number.

9. The system of claim 1, wherein the instructions further cause the processor to:
determine, using an inventory management system, whether all materials required to complete the repair process are available; and
responsive to determining that all the materials required to complete the repair process are not available, execute a remedial action.

10. The system of claim 9, wherein the remedial action is an action selected from the group consisting of: provide, using the display, a visual notification to the user, provide an audio notification to the user, provide, using the display, a method to obtain at least one of the materials required, and automatically obtain at least one of the materials required.

11. The system of claim 1, the at least one repair step for the vehicle includes an identification of at least one tool necessary to perform the at least one repair step.

12. The system of claim 11, wherein the instructions are further executable by the processor to automatically provide the at least one tool with data associated with the at least one repair step.

13. The system of claim 1, wherein the repair success metric modifies the customized repair algorithm based on previous repairs of similarly damaged vehicles.

14. The system of claim 1, wherein the instructions further cause the processor to determine whether calibration of an ADAS is needed after the vehicle has been structurally repaired.

15. The system of claim 1, wherein:
the processor is configured to communicate with at least one component of a set of tools,
the at least one component being usable to complete the at least one repair step for the vehicle,
the processor delivers programing instructions to the at least one component, and
the programing instructions render the at least one component operable to perform the at least one repair step for the vehicle.

16. A method of presenting equipment, wherein the equipment is configured to:
scan a vehicle repair estimate via a processor with artificial intelligence to and predict a severity and a location of damage to the vehicle;
develop a preferred set of repair procedures using the processor, wherein the procedures are based on the severity and location prediction, wherein the preferred set of repair procedures allow for repair of the vehicle;
deliver a set of programs to a set of equipment, wherein the set of equipment is required to perform a procedure of the preferred set of repair procedures, wherein the set of programs makes the set of equipment operable to perform the procedure;
deliver a set of instructions to a monitor, wherein the set of instructions include repair information;
perform each repair procedure of the set of repair procedures while using the set of equipment; and
update a set of vehicle history records.

17. The method of claim 16, wherein the equipment is further configured to determine if at least a portion of the vehicle is out of calibration and subsequently performing a calibration procedure.

18. The method of claim 16, wherein the set of equipment is queued for use with the vehicle repair.

19. The method of claim 18, wherein the set of equipment is removed from queue once the procedure of the preferred set of repair procedures is performed.

20. A system configured to identify, using an artificial intelligence module, at least one repair step for repairing a damaged vehicle; wherein the at least one repair step is based on:
a current condition of the damaged vehicle;
repair shop equipment;
repair part availability; and
prior repairs performed on similarly damaged vehicles.
